(19) United States
(12) Patent Application Publication
(10) Pub. No.: US 2014/0142933 A1
(43) Pub. Date: May 22, 2014

(54) DEVICE AND METHOD FOR PROCESSING VOCAL SIGNAL

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: YUAN YE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/084,743

(22) Filed: Nov. 20, 2013

(30) Foreign Application Priority Data
Nov. 22, 2012 (CN) 201210477149X

(51) Int. Cl. G10L 21/0316

(52) U.S. Cl. CPC G10L 21/0316
USPC 704/225

(57) ABSTRACT

A method processes vocal sounds captured by a sound capture device of an electronic device. The captured vocal sounds are divided into a plurality of sound segments, and a zero-crossing rate (ZCR) and amplitude of each of the sound segments are obtained. If one or more breathing sound segments are detected to be included in the captured vocal sounds according to the ZCR and the amplitude of each of the sound segments, the captured vocal sounds are processed to decrease the amplitude of the one or more breathing sound segments.

### BACKGROUND

1. Technical Field

Embodiments of the present disclosure relate generally to vocal signal processing technologies, and particularly, to a device and method for processing vocal signals.

2. Description of Related Art

Singing can be recorded using electronic devices, such as smart phones and personal computers. However, for some amateur singers, there may be unwanted sounds such as breathing sounds recorded with the singing, which decreases acoustical effects of the recorded singing. Therefore, there is room for improvement in the art.

### BRIEF DESCRIPTION OF THE DRAWINGS

FIG. 1 is a schematic block diagram of one embodiment of an electronic device.

FIG. 2 is flowchart of one embodiment of a method for processing vocal signals recorded by the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.” The reference “a plurality of” means “at least two.”

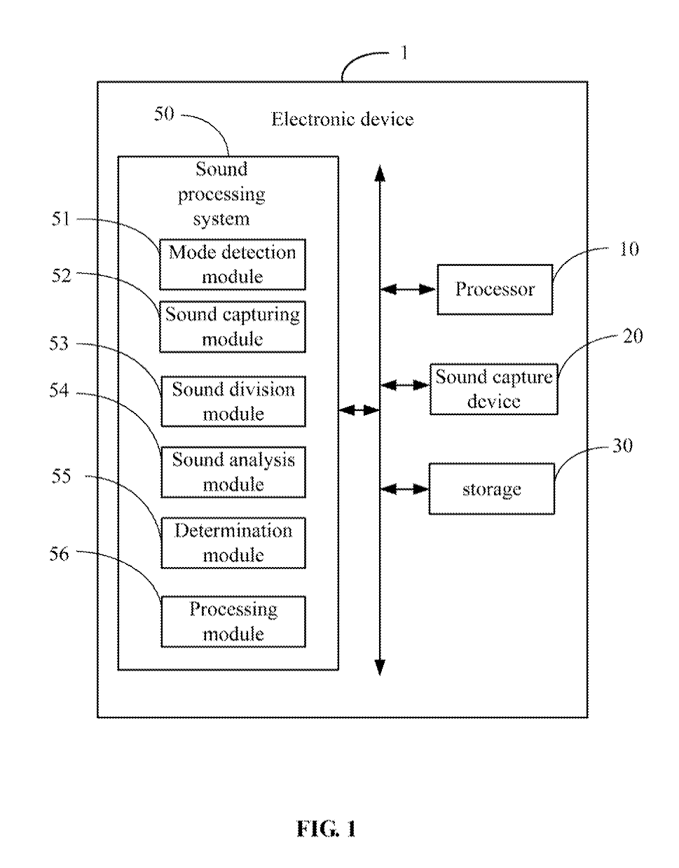

FIG. 1 is a schematic block diagram of one embodiment of an electronic device 1. The electronic device 1 includes a processor 10, a sound capturing device 20, a storage 30, and a sound processing system 50. The sound capturing device 20 captures vocal signals. The acquired vocal signals are stored in the storage 30 and processed by the sound processing system 50. The sound capturing device 20 can be a microphone of the electronic device 1. The electronic device can be a smart phone, a computer, a set-top box, or other similar device. The electronic device 1 can include more or fewer components than those shown in the embodiment of FIG. 1, and can have a different component configuration.

In this embodiment, the sound processing system 50 includes a mode detection mode 51, a sound capturing module 52, a sound division module 53, a sound analysis module 54, a determination module 55, and a processing module 56. The modules 51-56 include computerized codes in the form of one or more programs that are stored in the storage 30 or other storage mediums of the electronic device 1. The computerized codes include computer-readable program codes (instructions) that are executed by the processor 10 to provide functions for the electronic device 1. The storage 30 may be a cache or a dedicated memory, such as an erasable programmable read only memory (EPROM), a hard disk drive (HDD), or a flash memory.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

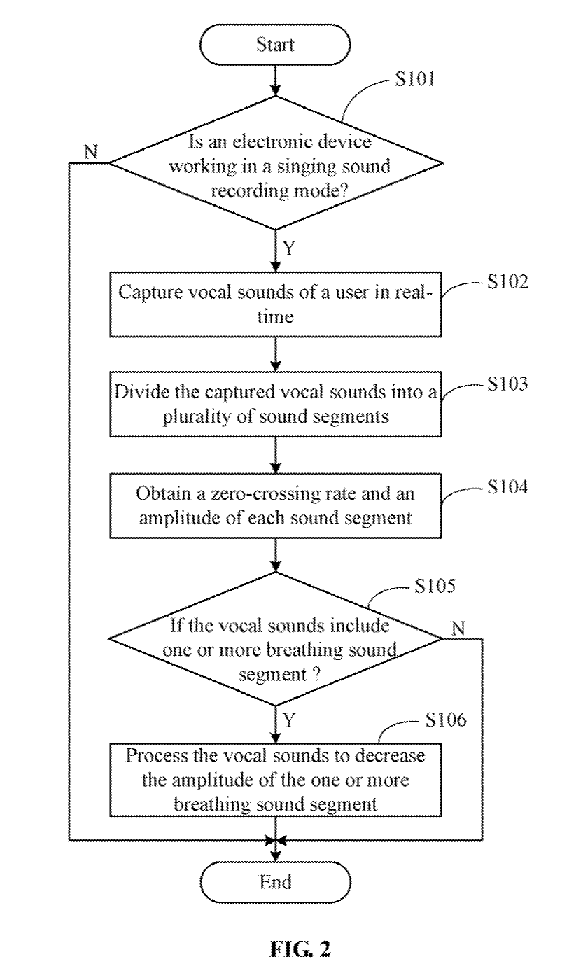

FIG. 2 is flowchart of one embodiment of a method for processing vocal sounds acquired by the sound capture device 20 using the functional modules of sound processing system 50 of FIG. 1. Depending on the embodiment, additional steps may be added, others removed, and the ordering of the steps may be changed.

In step S101, the mode detection module 51 detects whether the electronic device 1 is operating in a singing recording mode. In the embodiment, the electronic device 1 can be controlled to operate in the singing recording mode and record the singing of the user. In other embodiments, the mode detection module 51 and the step S101 can be omitted.

In step S102, when the electronic device 1 is working in the singing recording module, the sound capturing module 52 controls the sound capture device 20 to capture vocal sounds of the user in real-time, and stores the captured vocal sounds in the storage 30 to record the vocal sounds of the user.

In step S103, the sound division module 53 divides the captured vocal sounds into a plurality of sound segments. In this embodiment, each of the sound segments includes a predetermined time period (e.g., one second) of vocal sounds captured from the user.

In step S104, the sound analysis module 54 analyzes each of the sound segments to obtain a zero-crossing rate (ZCR) and an amplitude for each of the sound segments. The zero-crossing rate is a rate of sign-changes along a signal, for example, the rate at which the signal changes from positive to negative or negative to positive.

In step S105, the determination module 55 determines whether the captured vocal sounds include one or more breathing sound segments according to the ZCR and the amplitude of each of the sound segments. If the sound segments include one or more breathing sound segments, step S106 is implemented. Otherwise, the procedure ends.

In this embodiment, the determination module 55 compares the ZCR of each sound segment with a predetermined rate and compares the amplitude of each sound segment with a first predetermined amplitude and a second predetermined amplitude. The second predetermined amplitude is less than the first predetermined amplitude. If the ZCR of a sound segment is greater than the predetermined rate and the amplitude of the sound segment is greater than the second predetermined amplitude and less than the first predetermined amplitude, the sound segment is determined to be a breathing sound segment. Usually, the ZCR of a breathing sound is between 50%-80%. Therefore, the predetermined rate is greater than 50% and less than 80%. Particularly, the ZCR of most breathing sounds is greater than 70. In this regard, the predetermined rate can be set as about 70%.

In step S106, the processing module 56 processes the captured vocal sounds to decrease the amplitude of the one or more breathing sound segments of the captured vocal sounds until the amplitude of the one or more breathing sound segments is less than the second amplitude, thereby suppressing the interference of the one or more breathing sound segments to the captured vocal sounds. The processed vocal sounds are stored in the storage 30.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for processing vocal sounds captured by an electronic device, the electronic device comprising a sound capture device, the method comprising:
capturing vocal sounds of a user using the sound capture device in real-time;
dividing the captured vocal sounds into a plurality of sound segments;
obtaining a zero-crossing rate (ZCR) and an amplitude for each of the sound segments;
determining whether the captured vocal sounds include one or more breathing sound segment according to the ZCR and the amplitude of each of the sound segments; and
processing the captured vocal sounds to decrease the amplitude of the one or more breathing sound segments, when the captured vocal sounds include the one or more breathing sound segments.

2. The method according to claim 1, wherein each of the sound segments comprises a predetermined time period of vocal sounds captured from the user.

3. The method according to claim 2, wherein the predetermined time period is about one second.

4. The method according to claim 1, wherein the step of determining whether the captured vocal sounds include one or more breathing sound segments comprises:
comparing the ZCR of each sound segment with a predetermined rate; and
comparing the amplitude of each sound segment with a first predetermined amplitude and a second predetermined amplitude;
wherein the second predetermined amplitude is less than the first predetermined amplitude, and when the ZCR of a sound segment is greater than the predetermined rate and the amplitude of the sound segment is greater than the second predetermined amplitude and less than the first predetermined amplitude, the sound segment is determined to be a breathing sound segment.

5. The method according to claim 4, wherein the predetermined rate is greater than 50% and less than 80%.

6. The method according to claim 4, wherein the predetermined rate is about 70%.

7. The method according to claim 4, wherein the amplitude of the one or more breathing sound segments of the captured vocal sounds is decreased until the amplitude of the one or more breathing sound segments is less than the second amplitude.

8. The method according to claim 1, further comprising:
detecting whether the electronic device is working in a singing recording mode; wherein when the electronic device is working in the singing recording mode, the vocal sounds of the user are captured.

9. The method according to claim 1, further comprising:
storing the processed vocal sounds in a storage of the electronic device.

10. An electronic device, comprising:
a sound capture device;
a storage;
a processor; and
one or more programs executed by the processor, to perform a method of:
capturing vocal sounds of a user using the sound capture device in real-time;
dividing the captured vocal sounds into a plurality of sound segments;
obtaining a zero-crossing rate (ZCR) and an amplitude for each of the sound segments;
determining whether the captured vocal sounds include one or more breathing sound segments according to the ZCR and the amplitude of each of the sound segments; and
processing the captured vocal sounds to decrease the amplitude of the one or more breathing sound segments, when the captured vocal sounds include the one or more breathing sound segments.

11. The electronic device according to claim 11, wherein each of the sound segments comprises a predetermined time period of vocal sounds captured from the user.

12. The electronic device according to claim 11, wherein the predetermined time period is about one second.

13. The electronic device according to claim 11, wherein the step of determining whether the captured vocal sounds include one or more breathing sound segments comprises:
comparing the ZCR of each sound segment with a predetermined rate; and
comparing the amplitude of each sound segment with a first predetermined amplitude and a second predetermined amplitude;
wherein the second predetermined amplitude is less than the first predetermined amplitude, and when the ZCR of a sound segment is greater than the predetermined rate and the amplitude of the sound segment is greater than the second predetermined amplitude and less than the first predetermined amplitude, the sound segment is determined to be a breathing sound segment.

14. The electronic device according to claim 13, wherein the predetermined rate is greater than 50% and less than 80%.

15. The electronic device according to claim 13, wherein the predetermined rate is about 70%.

16. The electronic device according to claim 13, wherein the amplitude of the one or more breathing sound segments of the captured vocal sounds is decreased until the amplitude of the one or more breathing sound segments is less than the second amplitude.

17. The electronic device according to claim 11, wherein the method further comprises:
detecting whether the electronic device is working in a singing recording mode; wherein when the electronic device is working in the singing recording mode, the vocal sounds of the user are captured.

18. The electronic device according to claim 11, wherein the method further comprises:
storing the processed vocal sounds in a storage of the electronic device.
